(19) United States
(12) Patent Application Publication
(10) Pub. No.: US 2006/0206790 A1
(43) Pub. Date: Sep. 14, 2006

(54) Document managing apparatus

(75) Inventors: Noriyuki Komamura, Mishima-shi (JP); Nobuhiro Shimogori, Kawasaki-shi (JP); Seiya Shimizu, Numazu-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/077,707

(22) Filed: Mar. 10, 2005

(51) Int. Cl. G06F 17/00

(52) U.S. Cl. 715/500

(57) ABSTRACT

A document managing apparatus manages files of a plurality of electronic data as documents, arranges each document in order of a document time based on an update time of each file to manage the document beforehand by a document management table, converts a fluctuation amount in accordance with a rotation amount of an input device into a document moving amount, and switches an image of the document displayed in the display in accordance with the document moving amount.

### BACKGROUND OF THE INVENTION

1. Field of the Invention

The present invention relates to a document managing apparatus which manages a document using an information processing apparatus such as a computer.

2. Description of the Related Art

There has heretofore been a document managing apparatus which displays an image of a document managed in accordance with user's operation. In this document managing apparatus, a user searches for a desired document by the displayed document image. In the conventional document managing apparatus, documents whose images are to be displayed are switched one by one in accordance with a key operation of a keyboard or a button operation of a mouse.

In the above-described conventional document managing apparatus, it is necessary to switch the documents whose images are to be displayed one by one in accordance with the key operation or the like. In the conventional document managing apparatus, the switching of one document requires one operation, and the documents cannot be continuously switched. Therefore, in the conventional document managing apparatus, there is a problem that the desired document cannot be easily found, or operation efficiency for switching the document whose image is displayed is not satisfactory especially in a case where a large number of documents are managed.

### BRIEF SUMMARY OF THE INVENTION

According to the present invention, there is provided a document managing apparatus comprising: a document management table which manages an order of a plurality of documents constituting management objects; a display which displays an image of one of the plurality of documents managed by the document management table; an input control unit which detects a fluctuation amount input into an input device; a processing unit to determine the order of the documents to be displayed in the display based on the fluctuation amount detected by the input control unit and the order of the document whose image is displayed in the display, when the input control unit detects the fluctuation amount input by the input device in a state in which one document image is displayed in the display; and a display control unit which switches the document image displayed in the display to a document image having the order determined by the processing unit.

According to the present invention, there is provided a document managing apparatus comprising: document managing means for managing an order of a plurality of documents which are management objects; displaying means for displaying an image of one of the plurality of documents managed by the document managing means; input controlling means for detecting a fluctuation amount input into an input device; processing means for determining the order of the documents to be displayed in the displaying means based on the fluctuation amount detected by the input controlling means and the order of the document whose image is displayed in the displaying means, when the input controlling means detects the fluctuation amount input by the input device in a state in which one document image is displayed in the displaying means; and display controlling means for switching the document image displayed in the displaying means to a document image having the order determined by the processing means.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing a constitution example of a document managing apparatus according to an embodiment of the present invention;

FIG. 2 is a diagram showing a constitution example of a mouse;

FIG. 3 is a diagram showing a display example of a document searching screen (display screen of a document) displayed in a display of the document managing apparatus;

FIG. 4 is a diagram showing a relation between a document managed by the document managing apparatus and an image displayed in an image display region;

FIG. 5 is a diagram showing a constitution example of a first file management table;

FIG. 6 is a diagram showing a constitution example of a second file management table;

FIG. 7 is a diagram showing a constitution example of a document management table;

FIG. 8 is a diagram showing a constitution example of the document management table;

FIG. 9 is a diagram showing a constitution example of the document management table;

FIG. 10 is a diagram showing a constitution example of a color management table;

FIG. 11 is a flowchart showing a registering process of document management information in the document managing apparatus;

FIG. 12 is a flowchart showing an image producing process in the document managing apparatus;

FIG. 13 is a flowchart showing a displaying process of the document searching screen in the document managing apparatus;

FIG. 14 is a flowchart showing a document map producing process in the document managing apparatus;

FIG. 15 is a flowchart showing a document searching process in the document managing apparatus;

FIG. 16 is a flowchart showing the document searching process in the document managing apparatus;

FIG. 17 is a flowchart showing the document searching process in the document managing apparatus;

FIG. 18 is a flowchart showing a first modification of the document searching process using a mouse wheel; and

FIG. 19 is a flowchart showing a second modification of the document searching process using the mouse wheel.

### DETAILED DESCRIPTION OF THE INVENTION

An embodiment of the present invention will be described in detail with reference to the drawings.

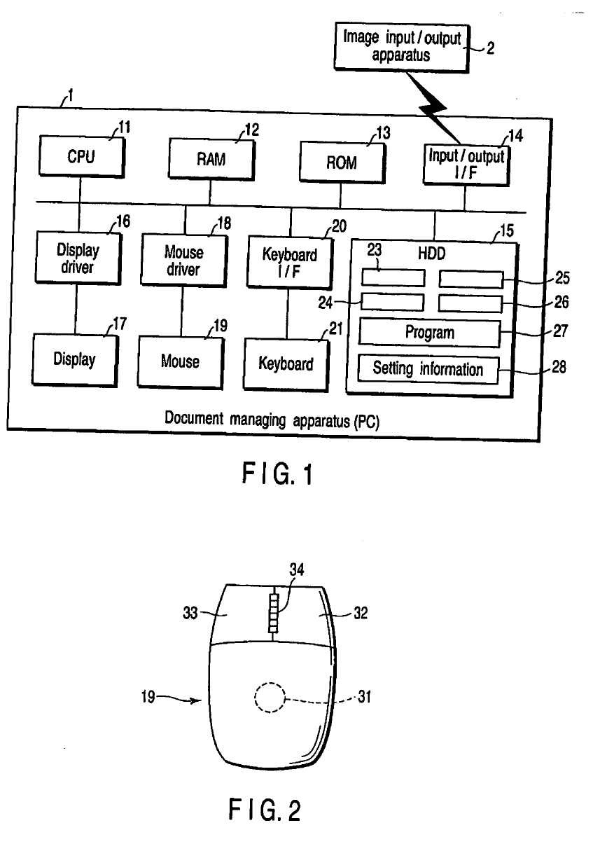

FIG. 1 is a block diagram schematically showing a constitution example of a document managing apparatus 1 according to an embodiment of the present invention.

The document managing apparatus 1 comprises a PC or the like connected to an image input/output apparatus 2. The image input/output apparatus 2 is not limited as long as the apparatus supplies an image to the document managing apparatus 1 which is the PC. Assumed examples of the image input/output apparatus 2 include a scanner, a digital complex machine (MFP) comprising the scanner, a digital camera, a computer on network (e.g., network disk or WWW server) and the like.

As shown in FIG. 1, the document managing apparatus 1 comprises a CPU 11, a RAM 12, a ROM 13, an input/output interface (I/F) 14, a hard disk drive (HDD) 15, a display driver 16, a display 17, a mouse driver 18, a mouse 19, a keyboard interface (I/F) 20, a keyboard 21 and the like. The mouse 19 and the keyboard 21 are input devices.

The CPU 11 executes a general control of the document managing apparatus 1. The CPU 11 executes a control program stored in the ROM 13 or an application program stored in the HDD 15 to thereby realize various functions. The RAM 12 is a memory which temporarily stores data for operation and the like. The ROM 13 is a nonvolatile memory in which a basic control program for operating the document managing apparatus (PC) 1 is stored beforehand.

The input/output interface 14 is an interface for inputting data such as an image from an external apparatus. In the constitution example shown in FIG. 1, the input/output interface 14 functions as an interface for acquiring an image from the image input/output apparatus 2. It is to be noted that FIG. 1 shows one input/output interface 14, but the document managing apparatus 1 may be provided with a plurality of input/output interfaces 14.

The HDD 15 is a storage device comprising a magnetic disk and the like. In the HDD 15, various types of data are stored in a file form. That is, the data constituting the document which is the management object of the document-managing apparatus 1 is stored as a file in the HDD 15.

Moreover, the HDD 15 is provided with a first file management table 23 which is a data table, a second file management table 24, a document management table 25, a color management table 26 and the like.

The first and second file management tables 23 and 24 are tables to store management information (file management information) concerning the file of the data constituting the document which is the management object. The document management table 25 is a table to store management information (document management information) on the document which is the management object. The color management table 26 is a table to store information (color management information) on a color associated with the document which is the management object. It is to be noted that the respective data tables 23 to 26 will be described later in detail.

Moreover, in the HDD 15, at least an application program (program for document management) 27 for allowing a PC to function as the document managing apparatus 1, and setting information 28 are stored.

The program 27 for document management comprises a program for allowing the PC to execute various types of processes such as a registering process of the document management information, an image producing process, a displaying process of a document searching screen, a document map producing process, and a document searching process. That is, when the program 27 for document management is executed, the PC realizes various types of functions such as a function of registering the document management information, a function of producing an image, a function of displaying the document searching screen, a function of producing a document map, and a function of searching the document.

The display driver 16 comprises a driving circuit which controls display contents of the display 17. The display driver 16 functions as an interface which outputs a signal of an image displayed in the display 17 to the display 17. The mouse driver 18 comprises a circuit which detects information input into the mouse 19 and the like. The mouse driver 18 detects movement of the mouse 19, input into a button disposed in the mouse 19, a rotation amount of a wheel disposed in the mouse 19 or the like. The mouse driver 18 notifies the CPU 11 of a signal indicating movement of the mouse 19, the input into the button of the mouse 19, the rotation amount of the wheel of the mouse 19 or the like.

The keyboard interface 20 detects information input in the keyboard 21, and notifies the CPU 11 of the information. The keyboard 21 comprises a plurality of keys of characters, numerals, symbols and the like. The input into each key of the keyboard 21 is detected by the keyboard interface 20, and notifies to the CPU 11 as a signal indicating the input key.

FIG. 2 is a diagram showing a constitution example of the mouse 19.

As shown in FIG. 2, the mouse 19 has an operation detection mechanism 31, a right button 32, a left button 33, a wheel 34 and the like. The mouse 19 is operated in a state shown in FIG. 2 when laid on a flat face. The mouse 19 having the state shown in FIG. 2 is held with user's hand. The user moves the mouse 19 having the state shown in FIG. 2 on the flat face, and operates the right button 32, left button 33, and wheel 34 if necessary.

The operation detection mechanism 31 is a mechanism for converting the movement of the mouse 19 on the flat face into a signal. For example, the operation detection mechanism 31 comprises a spherical body which rotates in accordance with the movement of the mouse 19, and a mechanism which converts the movement of the spherical body into the signal. The operation detection mechanism 31 may comprise an optical sensor which detects the movement of the mouse 19 on the flat face, the mechanism which converts the movement of the mouse 19 detected by the optical sensor into a signal. The operation detection mechanism 31 is disposed on a side brought into contact with the flat face in the state shown in FIG. 2. That is, when the user moves the mouse 19 held in the state shown in FIG. 2, the operation detection mechanism 31 detects the movement of the mouse 19 on the flat face. The signal indicating the movement of the mouse detected by the operation detection mechanism 31 is output to the mouse driver 18.

The right button 32 is a button disposed on the right side of a mouse 19 main body in the state shown in FIG. 2. The right button 32 is a button operated by user's index finger, middle finger or the like in a case where the user holds the mouse 19 main body having the state shown in FIG. 2 with user's right hand. The left button 33 is a button disposed on the left side of the mouse 19 main body in the state shown in FIG. 2. The left button 33 is operated by user's middle finger, third finger or the like in a case where the user holds the mouse 19 main body having the state shown in FIG. 2 with user's right hand.

The wheel 34 is a rotary member disposed in the vicinity of a middle portion of the mouse 19 in the state shown in FIG. 2. In the example shown in FIG. 2, the wheel 34 is disposed between the right button 32 and the left button 33. For example, the wheel 34 is operated with the index finger, middle finger, third finger or the like of the user who holds the mouse 19 main body having the state shown in FIG. 2.

Moreover, the wheel 34 is disposed in such a manner as to rotate only in a certain direction. In the example shown in FIG. 2, the wheel 34 rotates in a direction an inward direction (upward direction of FIG. 2) and a reverse direction (downward direction of FIG. 2). In the following description, as to the rotation direction of the wheel 34, it is assumed that an inward (upward in FIG. 2) rotation direction is a positive direction, and a frontward (downward in FIG. 2) rotation direction is the reverse direction.

Furthermore, the wheel 34 may function as a button. In this case, the wheel 34 is constituted in such a manner as to perform a specific input, when the wheel 34 itself is pressed. Additionally, the wheel 34 may be constituted in such a manner as to perform a specific input, when pressed toward the right or left.

Next, a display screen (document searching screen) will be described with respect to the document managed by the document managing apparatus 1.

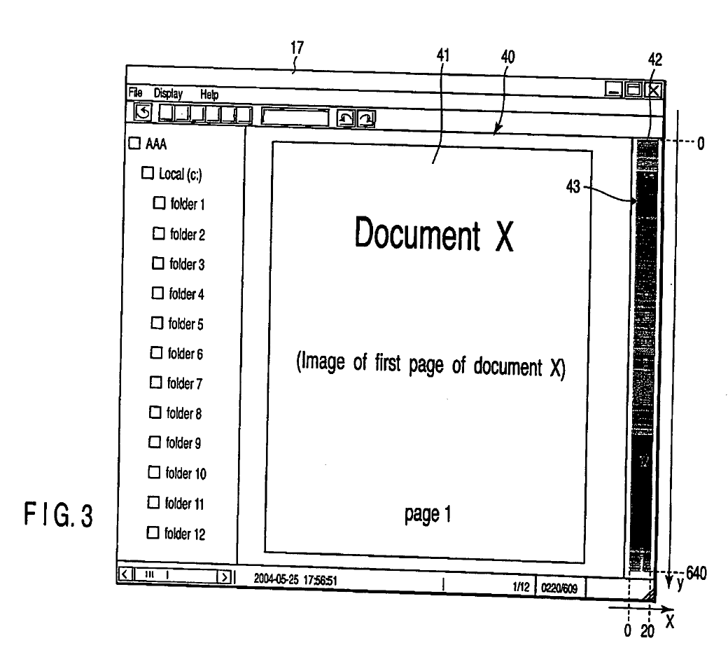

FIG. 3 is a diagram showing a display example of a document searching screen (display screen of the document) 40 displayed in the display 17 of the document managing apparatus 1.

In the document managing apparatus 1, the document searching screen 40 is displayed in a display window displayed in the display 17. As shown in FIG. 3, the document searching screen 40 displays an image of each page constituting the document managed by the document managing apparatus 1 every page unit in accordance with user's operation. The user searches the desired document with reference to the image displayed in the document searching screen 40 shown in FIG. 3.

In the display example shown in FIG. 3, the document searching screen 40 displays tool bars including various types of operation keys, and additionally an image display region 41, a document map (bar for searching) 42, a pointer (arrow) 43 and the like.

The image display region 41 is a substantially middle region of a display window which is the document searching screen 40 displayed in the display 17. Images of one or a plurality of pages constituting the document are displayed every page unit in accordance with user's operation in the image display region 41.

The document map 42 is displayed in a right-end region of the document searching screen 40. In the document map 42, bars (lines) indicating the respective documents managed by the document managing apparatus 1 are stacked and displayed in order of time series. This shows that the respective documents managed by the document managing apparatus 1 are stacked. In the document map 42 shown in FIG. 3, an uppermost bar indicates a document (newest document) having latest document time and a lowermost bar indicate a document (oldest document) having an oldest document time. That is, in the document map 42 shown in FIG. 3, the upper bar indicates a newer document, and the lower bar indicates an older document among the bars.

The pointer 43 is displayed in a region adjacent to the document map 42 in the document searching screen 40. The pointer 43 indicates a position of the bar on the document map 42, and the bar indicates a document to which the image displayed in the image display region 41 belongs. That is, the pointer 43 indicates the position of the bar indicating the document being display in the document map 42.

Moreover, in the document map 42, each bar corresponding to each document is displayed in a color associated with each document. The color of each bar corresponding to each document displayed in the document map 42 is set for each folder in which the file of the data constituting the document is stored. In this case, the document whose data is stored in the same folder is displayed in the same color. The document whose data is stored in a different folder is displayed in a different color. Accordingly, the user can intuitively recognize the folder in which each document is stored by the color displayed in the document map 42. It is to be noted that the color of the bar corresponding to each document displayed in the document map 42 may be set for each extension of each file which is the document, or each application for opening the document.

Next, switching of an image will be described which is displayed in the image display region 41 of the document searching screen 40.

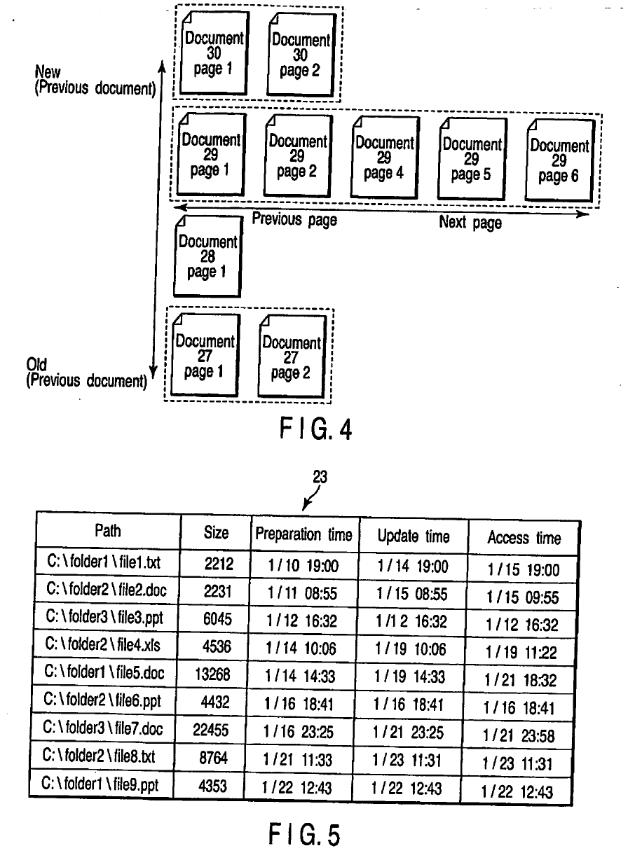

FIG. 4 is a diagram showing a relation between a document managed by the document managing apparatus 1 and an image displayed in the image display region 41.

Each document managed by the document managing apparatus 1 is constituted of one or a plurality of pages as shown in FIG. 4. The image shown in the image display region 41 of the document searching screen 40 shown in FIG. 3 is switched in response to an input of the mouse 19 or keyboard 21. The switching of the image displayed in the image display region 41 includes the switching of the document and the switching of the page.

In the document managing apparatus 1, as shown in FIG. 4, a plurality of documents are managed in order of time series based on a document time such as a document preparation time and an update time. The order of each document is also reflected in display order of the bar corresponding to each document stacked and displayed in the document map 42. Therefore, as shown in FIG. 3, the bars corresponding to the respective documents are stacked/displayed in order of time series in the document map 42.

Furthermore, in the document managing apparatus 1, as shown in FIG. 4, a plurality of pages in each document are managed in order of page.

In the document managing apparatus 1, the document displayed in the document searching screen 40 is switched in response to the operation of the mouse 19 or the keyboard 21 in a vertical direction (up/down direction of FIG. 3). Further in the document managing apparatus 1, the page displayed in the document searching screen 40 is switched in response to the operation of the mouse 19 or the keyboard 21 in a lateral direction (right/left direction of FIG. 3).

That is, when the user performs the operation in the vertical direction with the mouse 19, the keyboard 21 or the like, the document managing apparatus 1 switches the document to be displayed in the image display region 41 of the document searching screen 40. As a result, the image display region 41 of the document searching screen 40 displays a representative image (e.g., the image of a first page of the document) of the document switched in response to the operation in the vertical direction by the user. When the user performs the operation in the lateral direction with the mouse 19, the keyboard 21 or the like, the document managing apparatus 1 switches the page to be displayed in the image display region 41 of the document searching screen 40. As a result, the image display region 41 of the document searching screen 40 displays an image of the page switched in response to the operation in the lateral direction by the user.

First, the switching will be described with respect to the image to be displayed in the image display region 41 of the document searching screen 40 every document unit.

The document is switched, when the user instructs the switching of the document by an input device, for example, the mouse 19, the keyboard 21 or the like. Here, as described above, the document which is the image to be displayed in the image display region 41 is switched in response to the operation in the vertical direction (up/down direction). For example, the document is switched in response to the input into an up/down cursor key (up and down keys) of the keyboard 21, or the operation in the vertical direction by the pointing device like the mouse 19 or the like. In the present embodiment, the document is switched in accordance with the rotation of the wheel 34 of the mouse 19. The switching of the document by the wheel 34 of the mouse 19 will be described later in detail.

When the document is switched by the above-described operation, the image of the first page is displayed as the representative image of the document in the image display region 41 of the document searching screen 40. That is, every time the document is switched by the mouse 19, the keyboard 21 or the like, the image of the first page of each document is successively displayed in the image display region 41. It is to be noted that a specific page among the respective pages of the document may be set as the representative image of each document.

That is, to switch the representative image (image of the first page) of the document displayed in the image display region 41, the user instructs the switching of the document by the input device like the mouse 19 or the keyboard 21. Then, the document managing apparatus 1 successively switches the image of the first page of the document displayed in the image display region 41 in order of time series of each document.

Next, a case will be described where the image displayed in the image display region 41 of the document searching screen 40 is switched every page unit.

The page is switched, when the user instructs the switching of the page by the input device like the mouse 19, the keyboard 21 or the like. Here, as described above, the page which is the image to be displayed in the image display region 41 is switched in response to the operation in the lateral direction. For example, the page is switched in response to the input into a right/left cursor key (right and left keys) of the keyboard.

Every time the page is switched by the above-described operation, the image of each page constituting the document being displayed is successively displayed in the image display region 41 of the document searching screen 40. That is, to display the specific page of the specific document in the image display region 41, the user first displays the image of the first page of the desired document in the image display region 41 by the above-described switching of the document. In this display state, the user instructs the switching of the page by the mouse 19 or the keyboard 21. Then, the document managing apparatus 1 successively displays the image of each page constituting the document being displayed in the image display region 41 in order of page.

Next, various types of data tables 23 to 26 will be described for managing the document in the document managing apparatus 1 constituted as described above.

In the document managing apparatus 1, the data constituting each document which is a management object is stored as a file in the HDD 15. The file of the data constituting the document stored in the HDD 15 is managed by the first and second file management tables 23, 24. Management information of the document corresponding to the file stored in the HDD 15 is managed by the document management table 25. The color of the bar is managed by the color management table 26. This bar indicates each document in the document map 42 of the document searching screen 40.

First, the first and second file management tables 23, 24 will be described.

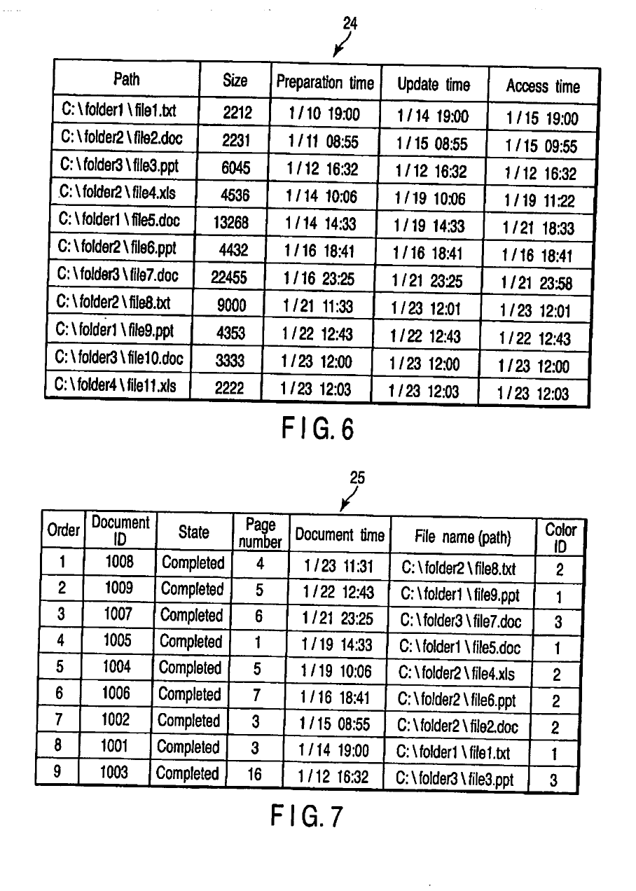

FIG. 5 is a diagram showing a constitution example of the first file management table 23. FIG. 6 is a diagram showing a constitution example of the second file management table 24.

The first and second file management tables 23, 24 are tables to store the management information on each file which is each document managed by the document managing apparatus 1.

As shown in FIGS. 5 and 6, the first and second file management tables 23, 24 are constituted to store the management information of each file, including a path, size, preparation time, update time, access time and the like.

As the path, information indicating a file name of the file is stored together with the information indicating names of a drive and a folder in which the file exists. A data size of the file is stored as the size. A date when the file was prepared is stored as the preparation time. A date when the file was updated is stored as the update time. As the access time, a date when the file was last accessed is stored.

Moreover, the management information of each file at a past time is stored in the first file management table 23. Here, the past time means, for example, a time when the document managing apparatus 1 was previously started. On the other hand, the second file management table 24 shows a list of existing files. Therefore, the second file management table 24 is updated in response to update and addition of the file at any time.

For example, when the document managing apparatus 1 is started, the information of the second file management table 24 at this time is stored as a first file management table, and a new second file management table 24 is prepared (updated). In the second file management table 24, management information is stored concerning a newly added file and an updated file. In other words, a difference between the file at the previous starting time and that at the present starting time appears as a difference between the first and second file management tables 23, 24. In the present embodiment, an updated situation (new registration or update) of the file is judged by the difference between the first and second file management tables 23, 24.

Here, as an example of the new registration of the file, a case is assumed where the document managing apparatus 1 acquires a document comprising a plurality of pages of images via the input/output interface 14. In this case, the data of the document acquired via the input/output interface 14 is stored as the newly registered file in the HDD 15. In this case, a field is added to the second file management table 24 in such a manner as to store the management information on the file, and a path, size, preparation time, update time, access time and the like are stored as the management information of the newly registered file. It is to be noted that in this case the information of the first file management table 23 is held without being changed.

Moreover, as an example of the update of the file, the update is assumed with respect to a file whose management information exists in the second file management table 24. In this case, the updated file is overwritten/stored in the existing file in the HDD 15. In this case, the management information of the file in the second file management table 24 is rewritten based on the file whose information has been updated including the size, update time, access time and the like. It is to be noted that also in this case, the information of the first file management table 23 is held without being changed.

Next, the document management table 25 will be described.

FIGS. 7, 8, and 9 are diagrams showing constitution examples of the document management table 25.

The document management table 25 is a table for managing as the document the file managed by the first file management table 23. As shown in FIGS. 7, 8, and 9, in the document management table 25, an order, document ID, state, page number, document date, file name, color ID and the like are stored as the management information on the document.

Information indicating a display order of each document is stored as the order. As described above, the respective documents are displayed in order of time series based on the document time in the document searching screen 40 shown in FIG. 3. Therefore, the order of each document is manufactured in a descending order of the document time in the document management table 25.

As the document ID, unique ID information is stored which is applied to each document in such a manner as to identify each document.

As the state, information is stored which indicates a processed state of each document is stored. For example, information indicating an “updated” state or a “completed” state is stored. The “completed” state indicates that the update (update or new registration) of the document has been completed. The “updated” state indicates that the document is waiting for the update (update or new registration).

As the page number, information is stored which indicates the page number of the document. The page number is determined, when the document is brought into the “completed” state.

As the document time, preparation or update time is stored with respect to each document. For example, as the document time, the update time is stored with respect to the file corresponding to the document managed in the first file management table 23.

As the file name, information is stored which indicates the file corresponding to the document. For example, as the file name, a drive name, folder name, and file name are stored with respect to the file corresponding to each document.

As the color ID, information is stored which indicates a color for displaying the information indicating each document. The color ID is unique ID information applied to each color for identifying the color. It is to be noted that the color management table 26 shows information indicating an actual color corresponding to the color ID.

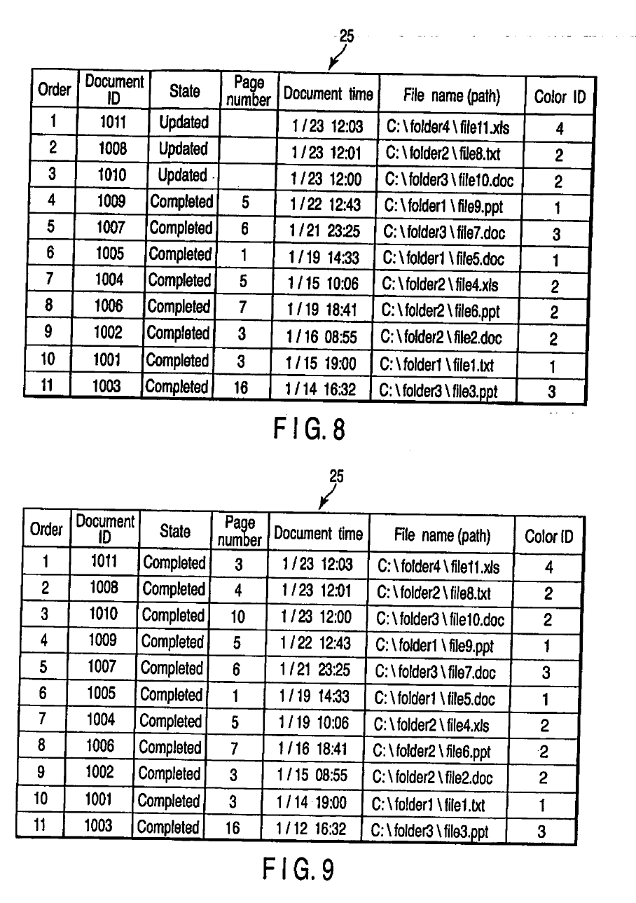

Moreover, the document management table 25 is updated by registration of the document management information described later. For example, nine documents are managed in the document management table 25 shown in FIG. 7. It is assumed that the document having document ID “1008” is updated, and documents having document IDs “1010” and “1011” are newly added in this state. In this case, in the registration of the document management information described later, three documents (document IDs “1008”, “1010”, “1011”) whose states have been set to be “updated” are registered in the document management table 25 shown in FIG. 7. In this case, the document management table 25 is prepared as shown in FIG. 8.

Furthermore, in the document management table 25 shown in FIG. 8, three documents having document IDs “1008”, “1010”, “1011” are brought into the “updated” states, and stored. As to the document set to the “updated” state in the document management table 25, images are successively produced as described later. When this image production is completed, the state of the document is rewritten into the “completed” state. Therefore, when the image production is completed with respect to three documents having the document IDs “1008”, “1010”, “1011”, the document management table 25 shown in FIG. 8 is rewritten into that shown in FIG. 9.

It is to be noted that the number of pages of each document is determined by the number of images produced by the image production described later. Therefore, in the document management table 25, as shown in FIG. 8, page-number columns of the respective documents brought into the “updated” states are blank. When the “updated” state of the document is changed into the “completed” state, as shown in FIG. 9, the number of images produced by the image production described later is stored as the page number.

Next, the color management table 26 will be described.

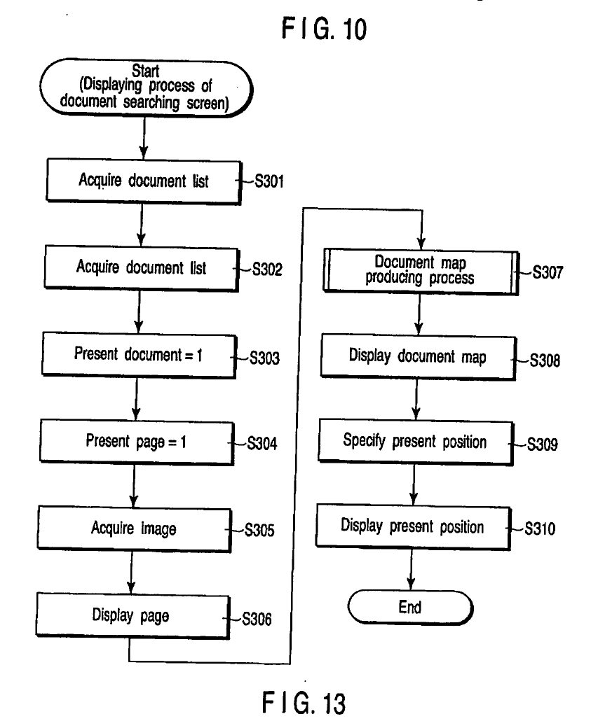

FIG. 10 is a document map showing a constitution example of the color management table 26.

In the color management table 26, the color ID, color (information indicating the actual color), and folder are associated. As described above, the color associated with each document is represented by the color ID in the document management table 25. Therefore, the color corresponding to each document is judged by the color ID of the document management table 25 and the color of the color management table 26. It is to be noted that the color associated with each document is the color of the bar corresponding to each document displayed in the document map 42 of the document searching screen 40.

Moreover, as described above, in the present embodiment, the color of the bar corresponding to each document displayed in the document map 42 of the document searching screen 40 is set for each folder. Therefore, in the color management table 26, as shown in FIG. 10, the color ID and the color are shown corresponding to each folder. It is to be noted that to set the color of the bar corresponding to each document displayed in the document map 42 for each extension of the file or each application for opening the document, in the color management table 26, the color ID and the color are stored corresponding to each extension or application.

Next, the registration of the document management information will be described in the document managing apparatus 1.

FIG. 11 is a flowchart showing a registering process of the document management information in the document managing apparatus 1.

First, to start the document managing apparatus 1, that is, to start the program 27 for document management by a PC which is the document managing apparatus 1, the CPU 11 first reads as previous file information the first file management table 23 in the HDD 15 (step S101). When the first file management table 23 is read, the CPU 11 reads as present file information the second file management table 24 in the HDD 15 (step S102).

On reading the first and second file management tables 23, 24, the CPU 11 performs a difference file detecting process to detect a difference between the management information (previous file information) of all files stored in the first file management table 23 and that (present file information) of all the files stored in the second file management table 24 (step S103). The information indicating a difference file detected by the difference file detecting process is temporarily stored, for example, in the RAM 12 or the like.

The difference file detecting process is a process to extract a file updated between a preparation time of the previous file information and the present time, or a newly added file. It is to be noted that the access time is not assumed as an object to be detected as the difference file in the present embodiment.

That is, the file which does not exist in the previous file information but which exists in the present file information, that is, the file existing only in the second file management table 24 is judged as the newly added file.

Moreover, the file whose update time in the present file information is different from that in the previous file information, that is, the file having the different update time in the first and second file management tables 23, 24 is judged as the updated file.

It is to be noted that the file which does not exist in the present file information but which exists in the previous file information, that is, the file existing only in the first file management table 23 is judged as a deleted file.

For example, a detecting process of the difference file by the first file management table 23 shown in FIG. 5 and the second file management table 24 shown in FIG. 6, three files having file names “file8.txt”, “file10.doc”, “file11.xls” are detected as the difference files.

In this case, as to the file (file name “file8.txt”) whose path is “C:\folder2\file8.txt”, the update date differs. Therefore, the file having the file name “file8.txt” is judged as the updated file.

The file (file name “file10.doc”) whose path is “C:\folder3\file10.doc”, and the file (file name “file11.xls”) whose path is “C:\folder4\file11.xls” exist only in the second file management table 24. Therefore, the files whose file names are “file10.doc” and “file11.xls” are judged as newly added files.

When the difference file is detected by the above-described difference file detecting process (step S104, YES), the CPU 11 successively reads the management information of the detected difference file to perform an updating process of the document management table 25 (steps S105 to S112). This updating process of the document management table 25 is repeatedly executed until the process is completed with respect to all the difference files detected by the difference file detecting process.

That is, when there is a difference file detected by the difference file detecting process (step S104, YES), the CPU 11 reads out one piece of management information of the difference file detected by the difference file detecting process (step S105). On reading out one difference file, the CPU 11 judges whether the difference file is the updated file (file whose update time has been changed) or the newly added file (step S106).

When it is judged that the read difference file is the updated file (step S106, YES), the CPU 11 updates the management information of the document corresponding to the file in the document management table 25 (step S107).

When it is judged that the read difference file is not the updated file, that is, when it is judged that the difference file is the newly added file (NO in the step S106), the CPU 11 judges whether or not the difference file is stored in a newly prepared folder (new folder) (step S108). In this judgment, it is judged whether or not the folder in which the file is stored is a folder in which the color is managed by the color management table 26 to thereby judge whether or not the folder is a new folder. That is, the folder whose color is set in the color management table 26 is judged as the existing folder.

For example, as to the file whose path is “C:\folder3\file10.doc”, the color is already assigned to the folder “C:\folder3” in the color management table shown in FIG. 10. In this case, it is judged that the folder “C:\folder3” is not a new folder. On the other hand, as to the file whose path is “C:\folder4\file11.xls”, any color is not assigned to the folder “C:\folder4” in the color management table shown in FIG. 10. In this case, it is judged that the folder “C:\folder4” is a new folder.

When it is judged that the folder is the new folder (step S108, YES), the CPU 11 produces the color to be assigned to the new folder (step 109). For example, it is assumed that a new color that is not assigned to any other folder is assigned to the new folder. A unique color ID is assigned to the produced color. On producing the color to be assigned to the new folder, the CPU 11 adds, to the color management table 26, the color information in which the color is associated with the color ID as the color information with respect to the new folder (step S110).

On adding the color information with respect to the new folder in which the difference file is stored, the CPU 11 performs a new document adding process to add to the document management table 25 the management information of the document corresponding to difference file (step S112).

Moreover, when it is judged that the folder is not the new folder (step S108, NO), by the color management table 26, the CPU 11 acquires the color ID to be assigned to the folder in which the file is stored (step S111). In this case, the CPU 11 performs the new document adding process to add to the document management table 25 the management information of the document corresponding to the difference file (step S112).

Furthermore, in the new document adding process of the steps S111 and S112, the management information of the document corresponding to the newly added file is produced with reference to the second file management table 24 and the color management table 26.

For example, the update time of the difference file is used in the document time in the management information of the document. The path of the difference file is used in the file name in the management information of the document. Newly produced unique information is used in the document ID in the management information of the document in such a manner as to be distinguished from the existing document. In the color ID in the management information of the document, the color ID of the color is used, this color being associated with the folder in which the difference file is stored. Additionally, a page-number column is blank in the management information of the document, and the state is set to be “updated” in the management information of the document. Accordingly, to produce image data from the file by an image producing process described later, the page number is determined in the management information of the document.

Additionally, in a case where the difference file is not detected by the difference file detecting process, or the process is completed with respect to all the difference files detected by the difference file detecting process (step S104, NO). The CPU 11 stores in the first file management table 23 the information stored as file information at this starting time in the existing second file management table 24 (step S113). Therefore, in the first file management table 23, file memory is stored in performing the difference file detecting process (this starting time). Accordingly, the information stored in the first file management table 23 is used as the previous file information at the next starting time.

By the above-described process, the management information of the document corresponding to the updated file and that of the document corresponding to the newly added file are registered in the document management table 25, while the states of the information are set to be “updated”. It is to be noted that the document having the “updated” state is brought into the “completed” state by a document image producing process described later, and the page number is determined.

Next, the document image producing process will be described.

In the registering process of the document management information, the management information of the documents corresponding to the updated file and the newly registered file, respectively, are registered as the information having the “updated” state in the document management table 25. The file having the “updated” state indicates that an image for display is not produced. Therefore, as to a document whose “state” is “updated”, the image for display needs to be produced. This process to produce the image for display of the document is referred to as the image producing process.

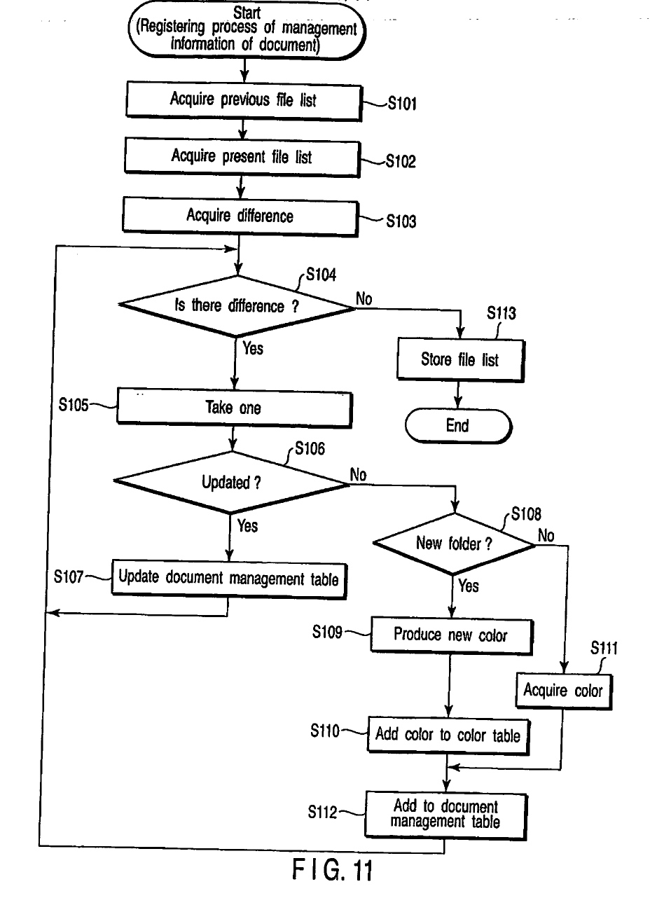

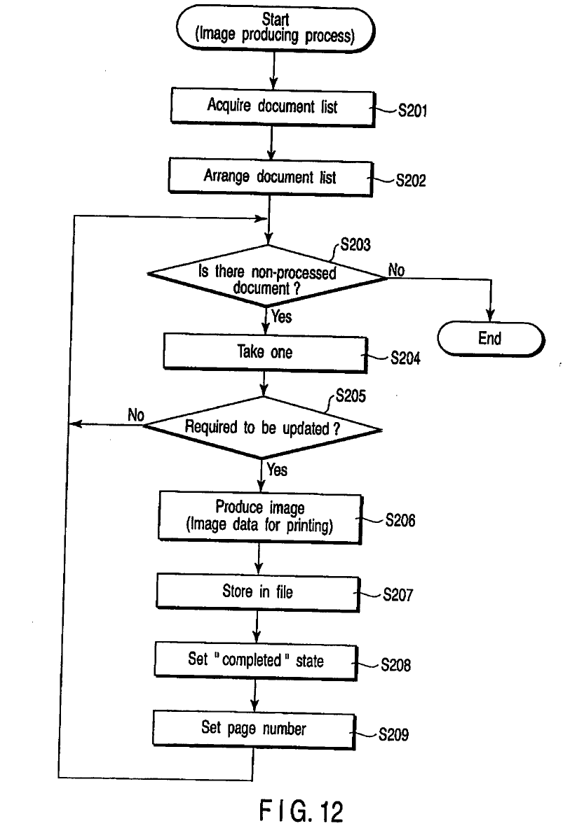

FIG. 12 is a flowchart showing an image producing process in the document managing apparatus 1.

That is, when the above-described registering process is completed with respect to the document management information, the CPU 11 performs the image producing process to produce an image for display. When the image producing process is started, the CPU 11 reads the management information of all documents from the document management table 25 (step S201). On reading the management information of the document from the document management table 25, the CPU 11 arranges the management information of all the documents based on the document time in the management information of each document (step S202). Accordingly, in the document management table 25, the management information of all the documents is rearranged in order of document time (in order of time series). For example, in the example shown in FIG. 8, three newest documents are brought into the “updated” state.

On arranging the management information of the document in the document management table 25 based on the document time, the CPU 11 judges whether or not the document (non-processed document) exists which is not subjected to the image producing process (step S203). When it is judged in this judgment that the non-processed document exists, the CPU 11 reads out the management information of the non-processed document every document (step S204). At this time, the CPU 11 first reads out a new time-series document.

On reading out the management information of one non-processed document, the CPU 11 judges whether or not the “state” is “updated” in the management information of the read document (step S205). When it is judged by the judgment that the “state” is “updated” (step S205, YES), the CPU 11 produces the image for display of the document (step S206).

It is to be noted that in this image producing process, a bitmap image is produced with respect to each page constituting the document as the image for display of the document. It is assumed in the present embodiment that image data for display of the document is prepared as image data for printing. The data of each document is formed in various forms such as text data and image data.

In the document managing apparatus 1, a document constituted of various modes of data is regarded as a management object. Therefore, in the document managing apparatus 1, data of each page constituting the document is produced as the image data for printing. As to the data having various forms used in various application programs, an image for printing is usually prepared in the application program. For example, when the document is the text data, the image for display of the document is produced, for example, as the image for printing by the application program of a word processor.

When the image data for printing is produced by this image producing process, the CPU 11 stores the image (image data for display of each page) of each page constituting the document as the file of the image data in the HDD 15 (step S207). Accordingly, the file of the image data as many as the pages of the document is stored in the HDD 15. On storing in the HDD 15 the file of the image data of each page of the document, the CPU 11 changes the “state” to the “completed” state in the management information of the document of the document management table 25. Furthermore, the CPU 11 specifies the page number from the file number produced as the image data, and sets the page number as the management information of the document in the document management table 25 (step S209).

Moreover, when there is not any non-processed document any more, that is, the “state” of all of the documents in the document management table 25 is set to be “completed” (step S203, NO), the CPU 11 ends the image producing process.

As described above, in the present embodiment, the image data for display of each document is produced as one file for each page of the document. The image data for display of each document may have any form such as TIF, PDF. A JPEG form is used in the present embodiment.

Additionally, as to each file of the image data for display, which is an image of each page, the file name can be specified from the document ID and the page number. For example, the file of the image data for display is stored with a file name “document ID-page number.jpg”.

For example, it is assumed that the document of “C:\folder4\file11.xls” comprises three pages of images in the document management table 25 shown in FIG. 8. In this case, in the producing process of the image for display concerning the document “C:\folder4\file11.xls”, the image data for display of three pages (file of three image data having the JPEG form) is produced.

Moreover, as to the document “C:\folder4\file11.xls”, as shown in FIG. 8, the document ID is “1011”. Therefore, as the image data for display of the document “C:\folder4\file11.xls”, three files having file names “1011-001.jpg”, “1011-002.jpg”, and “1011-003.jpg” are produced.

In this case, in the management information of the document whose document ID is “1011” in the document management table 25 shown in FIG. 8, as shown in FIG. 9, the “state” is set to be “completed”, and the “page number” is set to “3”. It is to be noted that FIG. 9 shows an example of the document management table 25 in a case where the image producing process is completed with respect to the document management table 25 having the state shown in FIG. 8.

It is to be noted that the image producing process may be executed in parallel with another process. That is, the image producing process may be executed in background of another process. For example, when there are many documents having the “updated” state, or there are many pages in the document whose “state” is “updated”, there is a possibility that much time is required for the image producing process. Therefore, even if the image producing process is being executed, the CPU 11 may perform a displaying process or the like of the document searching screen 40 described later.

Next, a displaying process will be described in a case where the document searching screen 40 (display window for document searching) is displayed.

FIG. 13 is a flowchart showing a displaying process of the document searching screen 40.

First, to display (start) the document searching screen 40, the CPU 11 first reads management information of all the documents stored in the document management table 25 (step S301). On reading the management information of all the documents stored in the document management table 25, the CPU 11 arranges the management information of all the read documents in order (in order of time series) from a latest document time (step S302).

When the management information of all the documents is arranged in order of time series, the CPU 11 secures, for example, a storage region for a present document (displayed document) which stores information indicating the present displayed document on the RAM 12. On securing the storage region of the present document, the CPU 11 sets information indicating a newest document in the storage region for the present document (step S303). Here, it is assumed that an “order” in which the document is stored as the management information in the document management table 25 is set as the information indicating the present document in the storage region of the present document. In other words, the CPU 11 indicates the presently displayed document (present document) by the “order” given to each document.

Furthermore, the CPU 11 secures, for example, a storage region for a present page (displayed page) which stores information indicating the presently displayed page number of the document on the RAM 12. On securing the storage region of the present page, the CPU 11 sets information indicating a representative page (first page in the present embodiment) in the storage region for the present page (step S304). Here, it is assumed that the page number is set as the information indicating the present page in the storage region of the present page.

That is, the CPU 11 displays the representative page (first page) of the newest document as an image of initial display. Therefore, the CPU 11 sets the present document as “1”, and sets the present page as “1”. On setting the present document to “1” and the present page to “1”, the CPU 11 acquires the file of the image data for display of the page (image of the page “1” in the document having the order “1”) (step S305).

In this image acquiring process, the file of the image data of the page to be displayed is specified with reference to the document management table 25. That is, the CPU 11 acquires the document ID corresponding to the “order” (“1” in this case) set as the present document with reference to the document management table 25. On acquiring the document ID of the present document, the CPU 11 specifies the file of the image data constituted of the document ID of the present document and the page number by the “page number” (“1” in this case) set as the specification.

For example, in the example of the document management table 25 shown in FIG. 9, the document ID having the “order” “1” is “1011”. In this case, the image file of the first page of the document ID “1011” is stored with the name “1011-001.jpg”. Therefore, when the present document is set as “1”, and the present page is set as “1”, the CPU 11 specifies “1011-001.jpg” as the file of the image data with reference to the document management table 25 shown in FIG. 9.

On acquiring the file of the image data by the above-described image acquiring process, the CPU 11 displays the image data of the file in the image display region 41 of the document searching screen 40 (step S306). On displaying the image data of the acquired file in the image display region 41, the CPU 11 performs a document map producing process to produce the document map 42 displayed in order of time series of all the documents (step S307). This document map producing process will be described later in detail.

On producing the document map 42 by the document map producing process, the CPU 11 displays the produced document map 42 in a predetermined display region in the document searching screen 40 (step S308). On displaying the document map 42 in the document searching screen 40, the CPU 11 specifies the position of the present document in the document map 42 (step S309). On specifying the position of the present document, the CPU 11 displays the pointer 43 indicating the position of the present document in the document map 42 (step S310).

By the above-described displaying process of the document searching screen, an initial screen is displayed as the document searching screen 40 in the display window in the display 17.

Next, the document map producing process will be described.

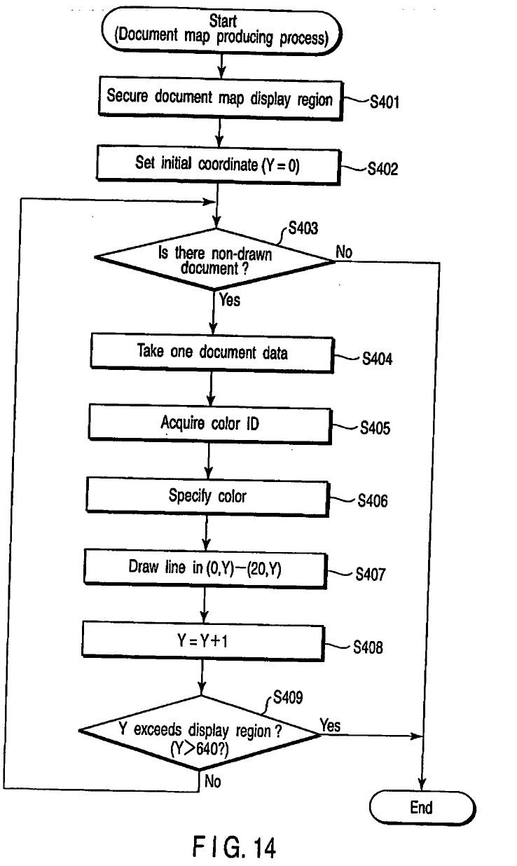

FIG. 14 is a flowchart showing the document map producing process.

On starting the producing process of the document map 42, the CPU 11 secures a display region for displaying the document map 42 in the document searching screen 40 (step S401). It is assumed that the display region of the document map 42 is set beforehand. In the step S401, it is assumed that the CPU 11 displays the secured display region of the document map 42 in a color which is an initial value, such as white.

For example, as shown in FIG. 3, the display region of the document map 42 is set as a right-end region of the document searching screen 40, which is sized in such a manner as to have a width of 20 pixels and a height of 640 pixels. It is to be noted that here, as shown in FIG. 3, the display region of the document map 42 is a rectangular region represented by coordinate value (X, Y) including four points (0, 0), (20, 0), (0, 640), (20, 640). It is to be noted that in the present embodiment, a Y-direction is defined as a vertical direction and an X-direction is defined as a lateral direction in the document searching screen shown in FIG. 3.

On securing the display region of the document map 42 in the document searching screen 40, the CPU 11 sets an initial coordinate value to start drawing (step S402). Here, as to the initial coordinate value, it is assumed that a Y-coordinate is set to “0” (Y=0) as an uppermost end of the display region of the document map 42.

On setting the initial coordinate value, the CPU 11 reads out the management information of the document from a small “order” in order from the document management table 25. That is, the CPU 11 judges whether or not a document (non-drawn document) whose bars are not drawn in the display region of the document map 42 exists in the document management table 25. When it is judged by this judgment that there is the non-drawn document in the document management table 25 (step S403), the CPU 11 reads out the management information of the document having a smallest “order” among the non-drawn documents (step S404).

On reading the management information of the document, the CPU 11 specifies the color ID assigned to the read document (step S405). On specifying the color ID of the document, the CPU 11 determines the actual color corresponding to the color ID of the document with reference to the color management table 26 (step S406). Accordingly, the determined color is a color in which the bar (line) indicating the document is drawn in the document map 42.

On judging the color in which the bar indicating the document is drawn, the CPU 11 draws the bar (line) indicating the document in the determined color in the present coordinate value in the display region of the document map 42 (step S407). Here, it is assumed that the bar indicating each document is a line having a width (height) for one pixel in the Y-direction. In this case, as to the first document, the bar having the width (height) for one pixel is drawn in the initial coordinate value ((0, Y) to (20, Y)) of Y in the display region of the document map 42.

On drawing the bar indicating the document, the CPU 11 sets “Y=Y+1” to thereby increase the coordinate value in the Y-direction by one pixel (step S408). When the coordinate value in the Y-direction is increased by one pixel, the CPU 11 judges whether or not the coordinate value in the Y-direction exceed the display region of the document map 42. When it is judged by this judgment that the coordinate value of the Y-direction exceeds the display region of the document map 42 (step S409, YES), the CPU 11 ends the producing process of the document map 42.

Moreover, when it is judged by this judgment that the coordinate value of the Y-direction does not exceed the display region (step S409, NO), the CPU 11 returns to the step S403. Accordingly, the CPU 11 repeatedly executes the above-described steps S403 to S409 until there is not any more non-drawn document in the display region of the document map 42. That is, the process in the steps S403 to S409 is repeatedly executed with respect to all the documents managed by the document management table 25.

By the above-described process, the document map 42 is produced in which the bars indicating the respective documents are stacked/displayed in order of time series in color corresponding to each document.

Next, a document searching process will be described.

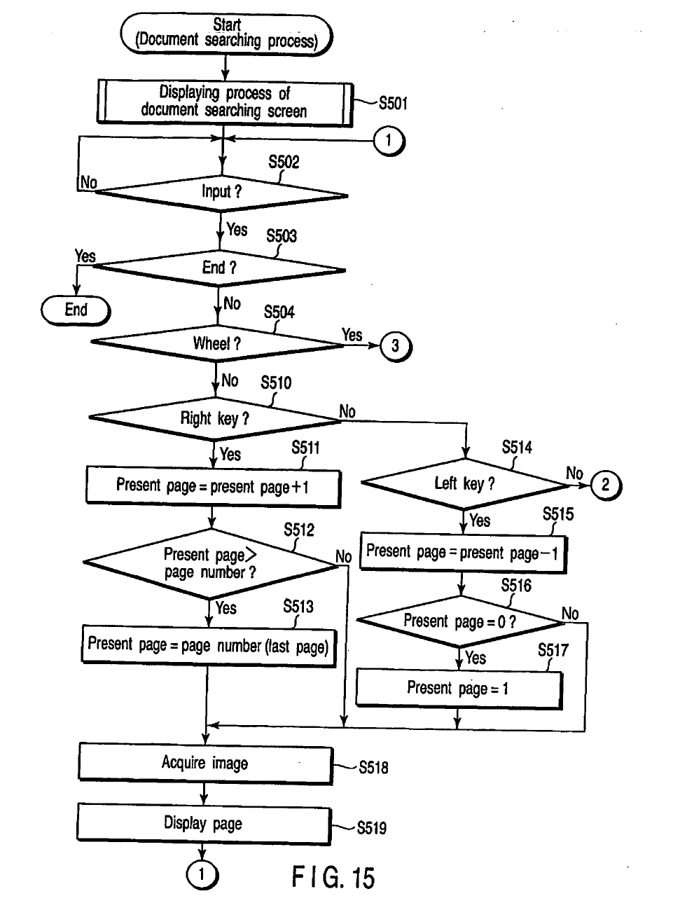

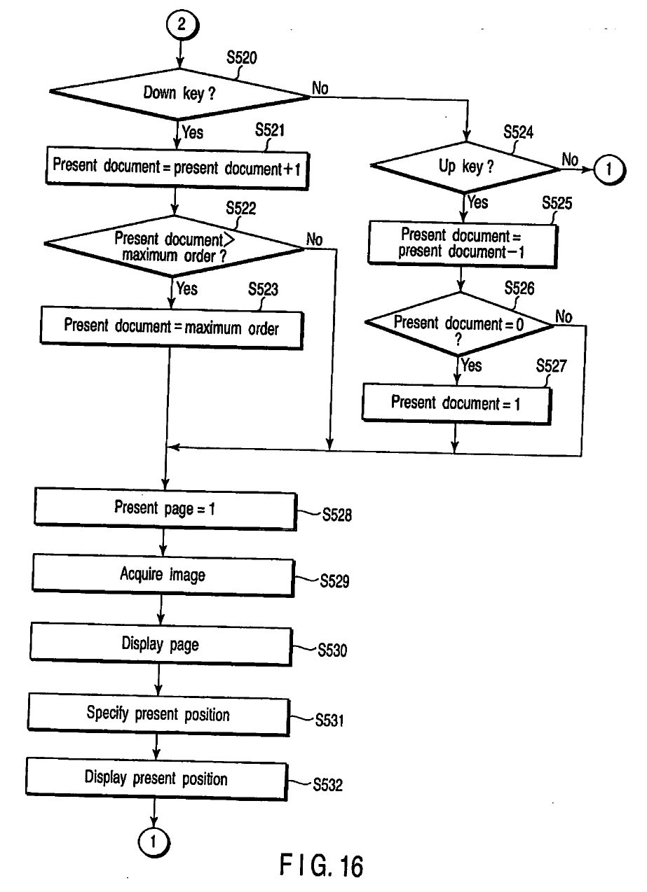

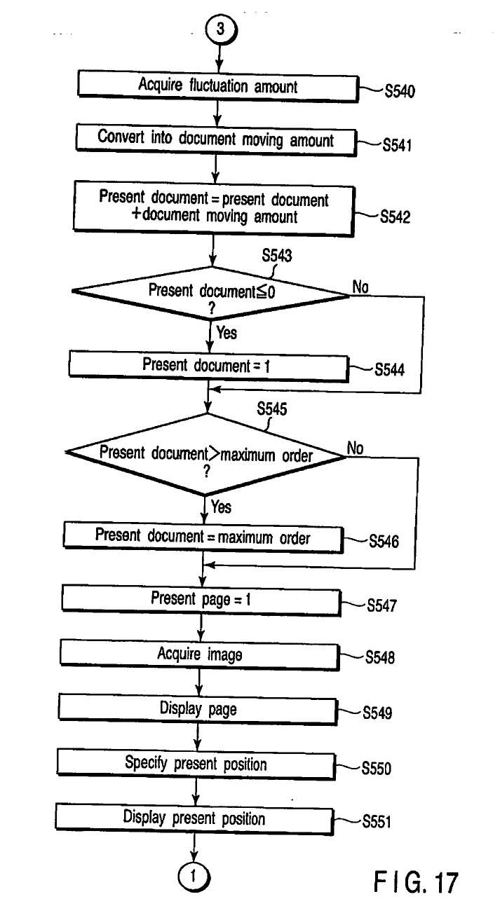

FIGS. 15, 16, 17 are flowcharts showing the document searching process.

First, it is assumed that the display 17 displays the document searching screen 40 displaying the image of the first page of the document having a latest document time by the above-described displaying process of the document searching screen (step S501). Since the process of the step S501 is similar to that of FIG. 13, description and flowchart of a sub-flow are omitted.

In this state, the CPU 11 waits for an input from a user by the mouse 19 or the keyboard 21 (step S502). In this state, the CPU 11 detects presence of an input into the mouse 19 or the keyboard 21. As to the input into the wheel 34 of the mouse 19, a rotation amount of the wheel 34 in a predetermined time is input as a fluctuation amount. As to the inputs into the respective keys of the keyboard 21 or the right/left buttons 32, 33, the key which has been input is detected.

On detecting the input into the mouse 19 or the keyboard 21 (step S502, YES), the CPU 11 judges whether or not input instruction contents indicate an instruction for end (step S503). When it is judged by this judgment that the input instruction contents indicate the instruction for the end (step S503, YES), the CPU 11 deletes the document searching screen 40 to end the process.

Moreover, when it is judged by the judgment that the input instruction contents do not indicate the instruction for the end (step S503, NO), the CPU 11 judges whether or not the input instruction contents indicate the input into the wheel 34 of the mouse 19 (step S504).

When it is judged that there is not any input into the wheel 34 of the mouse 19 (step S504, YES), the CPU 11 judges the input into the right key instructing movement to the right (step S510), the input into the left key instructing movement to the left (step S514), the input into the down key instructing downward movement (step S520), or the input into the up key instructing upward movement (step S524). It is to be noted that when the input is made into a key other than the right, left, down, and up keys, the CPU 11 returns to the step S502, and again waits for the input.

That is, when it is judged that there is an input into the right key (step S510, YES), the CPU 11 increases the present page by one to set “present page=present page+1” (step S511). In this case, the CPU 11 acquires the page number of the present document from the document management table 25, and judges whether or not the present page set in the step S511 exceeds the page number of the present document (step S512). When it is judged that the present page set in the step S511 exceeds the page number of the present document, the CPU 11 judges the present page as the page number of the present document, that is, the last page of the present document (step S513).

Moreover, when it is judged that there is an input into the left key (step S514, YES), the CPU 11 decreases the present page by one to set “present page=present page−1” (step S515). In this case, the CPU 11 judges whether or not the present page to be displayed is “0” (step S516). When it is judged that the present page set in the step S515 is “0”, the CPU 11 sets the present page to “1”, that is, the first page of the present document (step S517).

When the present page is changed by the steps S510 to S517, the CPU 11 acquires the document ID of the present document by correspondence between “order” and “document ID” in the document management table 25. On acquiring the document ID of the present document, the CPU 11 acquires the file of the image of the page by the document ID and the present page of the present document (step S518). On acquiring the file of the image of the page, the CPU 11 displays the image of the page in the image display region 41 of the document searching screen 40 (step S519).

Furthermore, when it is judged that there is an input into the down key (step S520, YES), the CPU 11 increases the present page by one to set “present document=present document+1” (step S521). In this case, the CPU 11 acquires a maximum order (“order” of the document having an oldest document time) from the document management table 25, and judges whether or not the present document set in the step S521 exceeds the maximum order (step S522). When it is judged here that the present document set in the step S521 exceeds the maximum order, the CPU 11 judges the document having the maximum order, that is, the oldest document time as the present document (step S523).

Moreover, when it is judged that there is an input into the up key (step S524, YES), the CPU 11 decreases the present document by one to set “present document=present document−1” (step S525). In this case, the CPU 11 judges whether or not the present document set in the step S525 is “0” (step S526). When it is judged that the present document set in the step S525 is “0”, the CPU 11 sets the document page to “1”, that is, the document having the latest document time (step S527).

When the present document is changed by the steps S520 to S527, the CPU 11 sets the present page to “1” which is the representative page of each document (step S519). When the present document and the present page are set in this manner, the CPU 11 acquires the document ID of the present document by the correspondence between the “order” and the “document ID” in the document management table 25. On acquiring the document ID of the present document, the CPU 11 acquires the file of the image of the page by the document ID and the present page of the present document (step S529). On acquiring the file of the image of the page, the CPU 11 displays the image of the page in the image display region 41 of the document searching screen 40 (step S530).

Furthermore, the CPU 11 specifies the position of the present document in the document map 42 of the document searching screen 40 (step S531). When the position of the present document is specified, the CPU 11 displays the arrow 43 indicating the position of the present document in the document map 42 (step S532). It is to be noted that the process of the steps S531 and S532 may be performed in parallel with that of the steps S528 to S530.

Additionally, when it is judged in the above-described judgment that there is an input into the wheel 34 of the mouse 19 (step S504, YES), the CPU 11 performs a document searching process in accordance with the rotation amount of the wheel 34 of the mouse 19.

That is, when it is judged in the judgment that there is an input into the wheel 34 of the mouse 19 (step S504, YES), the CPU 11 acquires the rotation amount of the wheel 34 within a predetermined time as a fluctuation amount (step S540). The rotation amount of the wheel 34 is detected by the mouse driver 18. The rotation amount of the wheel detected by the mouse driver 18 is notified with respect to the CPU 11. Accordingly, the CPU 11 acquires the rotation amount of the wheel 34 within the predetermined time as the fluctuation amount.

On acquiring the above-described fluctuation amount, the CPU 11 converts the acquired fluctuation amount into a document moving amount (step S541). The document moving amount indicates a moving document number and moving direction (rotation direction of the wheel). The moving document number indicates the number (number of documents to be moved) of documents to be switched. The moving direction corresponds to the rotation direction of the wheel, and indicates a direction in which the document is moved.

In the present embodiment, it is assumed that the moving direction is represented by a positive/negative value of the document moving amount. That is, when the wheel 34 is rotated in a positive direction, “document moving amount=+(moving document number)” is set, and the document moving amount is set to a positive value. When the document moving amount indicates the positive value in this manner, it is indicated that the documents are switched in “order”. When the wheel 34 is rotated in a reverse direction, “document moving amount=−(moving document number)” is set, and the document moving amount is set to a negative value. When the document moving amount indicates the negative value in this manner, it is indicated that the documents are switched in a reverse “order”.

For example, when the user rotates the wheel 34 in a forward direction, the document moving amount indicates a positive value, and it is indicated that the documents are switched in “order”. When the user rotates the wheel 34 in a reverse direction, the document moving amount indicates a negative value, and it is indicated that the documents are switched in the reverse “order”.

It is to be noted that a relation among the rotation amount of the wheel 34, the fluctuation amount, and the document moving amount will be described later in detail.

When the fluctuation amount based on the rotation amount input into the wheel 34 is converted into the document moving amount (step S541), the CPU 11 sets the present document to a document which has been moved by the document moving amount (“present document=present document+document moving amount”) (step S542). In this case, the CPU 11 judges whether or not the present document set in the step S542 indicates “0” or less (step S543). When it is judged that the present document set in the step S542 indicates “0” or less (step S543, YES), the CPU 11 sets the present document to “1”, that is, the document having the latest document time (step S544).

Moreover, when it is judged that the present document set in the step S542 does not indicate “0” or less (step S543, NO), the CPU 11 further acquires the maximum order (“order” of the document having the oldest document time) from the document management table 25, and judges whether or not the present document set in the step S542 exceeds the maximum order (step S545). Here, when it is judged that the present document set in the step S542 exceeds the maximum order (step S545, YES), the CPU 11 sets the present document to the maximum order, that is, the document having the oldest document time (step S546).

When the present document is changed by the steps S540 to S546, the CPU 11 sets the present page to “1” which is the representative page of each document (step S547). When the present document and the present page are set in this manner, the CPU 11 acquires the document ID of the present document by the correspondence between the “order” and the “document ID” in the document management table 25. On acquiring the document ID of the present document, the CPU 11 acquires the file of the image of the page by the document ID and the present page of the present document (step S548). On acquiring the file of the image of the page, the CPU 11 displays the image of the page in the image display region 41 of the document searching screen 40 (step S549).

Furthermore, the CPU 11 specifies the position of the present document in the document map 42 of the document searching screen 40 (step S550). On specifying the position of the present document, the CPU 11 displays the arrow 43 indicating the position of the present document in the document map 42 (step S551). It is to be noted that the process of the steps S550 and S551 may be performed in accordance with that of the steps S547 and S549.

As described above, in the process shown in FIGS. 15, 16, and 17, the fluctuation amount input by the user in accordance with the rotation amount of the wheel 34 of the mouse 19 is converted into the document moving amount, the documents arranged in order of time series are switched in accordance with the document moving amount, and the image of the document switched in accordance with the document moving amount is displayed in the display. Accordingly, the wheel 34 of the mouse 19 is rotated, and the document whose image of the first page is to be displayed can be efficiently switched. As a result, the user can efficiently search the document managed by the document managing apparatus 1, and can easily find a desired document.

Next, the relation among the rotation amount of the wheel 34 of the mouse 19, the fluctuation amount, and the document moving amount will be described.

The rotation amount of the wheel 34 of the mouse 19, the fluctuation amount acquired by the CPU 11, and the relation therebetween are set beforehand by setting information. It is assumed that the relation between the fluctuation amount and the document moving amount acquired by the CPU 11 is also set by the setting information. This setting information may be changed to an arbitrary value by the user. In the present embodiment, S540, S521, S525 correspond to an input control unit, S521, S525, S540 correspond to a processing unit, and S547 to S551 correspond to a display control unit.

For example, it is assumed that the fluctuation amount is “2880” with respect to one rotation of the wheel 34 of the mouse 19. In this case, when a moved document number is set to “1” with respect to the fluctuation amount of “1”, 2880 documents move with respect to one rotation of the wheel 34. Accordingly, as to an image (image of a representative page of each document) displayed in the image display region 41, images for 2880 documents are switched with one rotation of the wheel 34.

In this setting, a moving amount is excessively large with respect to the document displayed in the image display region 41. In this case, the user does not easily find the desired document from the image of the document displayed in the image display region 41. Therefore, the moved document number is set to “1” with respect to a fluctuation amount of “120”. In this setting, the documents displayed in the image display region 41 move by 24 documents with one rotation of the wheel 34. Therefore, the user can easily search the desired document.

Moreover, the wheel 34 of the mouse 19 is caught by a predetermined interval, that is, every constant rotation amount in some case. In the document managing apparatus 1 using the mouse 19 having this type of wheel 34, one document may be switched every catch interval accompanying the rotation of the wheel 34. This can be realized, when the moved document number is set to “1” with respect to the fluctuation amount corresponding to the rotation amount of the wheel 34 which is caught. In this case, one document switches every time the user operating the wheel 34 feels the catch. Therefore, an operation feeling is satisfactory.

Moreover, the moved document number with respect to the fluctuation amount may be set for each document. This can be realized, when the fluctuation amount is set beforehand as management information of each document with respect to a moved document number “1” in the document management table 25. When the fluctuation amount with respect to the moved document number “1” is set for each document, the moved document number with respect to the fluctuation amount input by the user is obtained by comparison of the fluctuation amount input by the user with a value obtained by accumulating the fluctuation amount with respect to the moved document number “1” of each document in order from the document being displayed.

For example, the fluctuation amount with respect to the moved document number “1” is set to be large as to a document having a high level of importance based on the level of importance or use frequency of each document, whereas the fluctuation amount with respect to the moved document number “1” is set to be small with respect to a document having a low level of importance. In this setting, when the wheel 34 is rotated at a constant ratio, an image of the document having the high level of importance is displayed for a long time, and an image of the document having the low level of importance is displayed only for a shirt time. When the wheel 34 is rotated at a stretch, a probability is high that the displayed document image switches to the image of the document having the high level of importance.

As described above, when the fluctuation amount with respect to the moved document number “1” of each document is set in accordance with the importance level or the use frequency of each document, the user easily finds the image of the document having the high importance level, and operability is enhanced.

Next, a first modification will be described with reference to the document searching process using the wheel 34.

In the first modification which is a modification of the document searching process using the wheel 34 of the mouse 19, when the document moving amount is smaller than a predetermined value (N), an image of a first page of the document displayed in the document searching screen 40 is switched for each document.

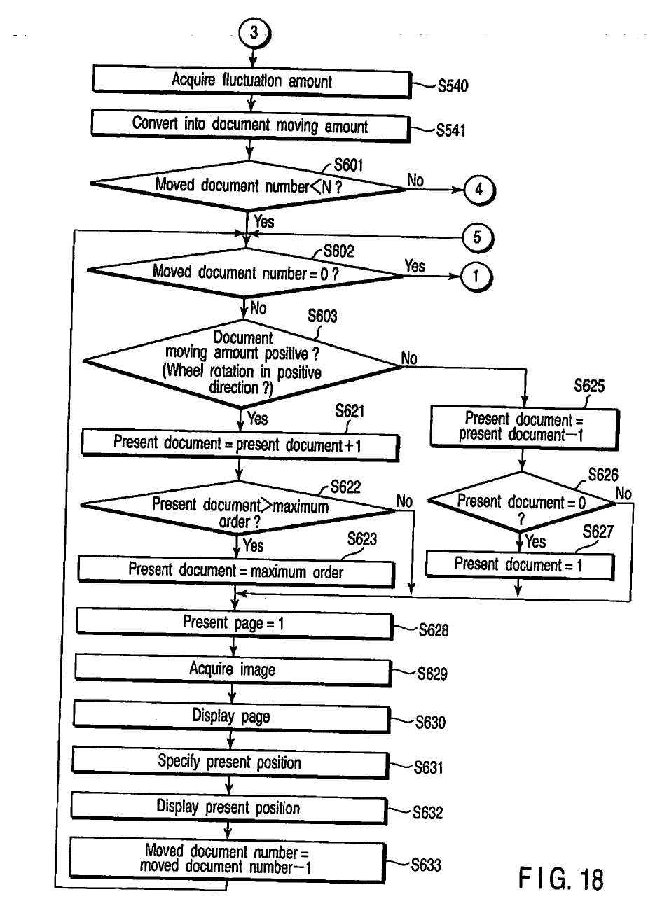

FIG. 18 is a flowchart showing the first modification of the document searching process using the wheel 34 of the mouse 19. The first modification shown in FIG. 18 is a modification of a process continued from that of the step S541. Specifically, the number (moved document number) of documents to be moved is based on the document moving amount carried in the step S541, and the first modification shows a process example in a case where the number is smaller than a predetermined value. Therefore, detailed description is omitted with respect to a process similar to the above-described process.

As described above, the document moving amount carried in the step S541 is a value indicating the number (moved document number) of the documents to be moved, and a rotation direction of the wheel 34. In the moved document number, the fluctuation amount with respect to the rotation amount of the wheel 34 is replaced with the number of documents at a predetermined ratio. The rotation direction of the wheel 34 is indicated by a positive or negative value of the document moving amount. That is, when the document moving amount indicates a positive value, it is indicated that the wheel 34 is rotated in a forward direction. When the document moving amount indicates a negative value, it is indicated that the wheel 34 is rotated in a reverse direction.

As shown in FIG. 18, in the present first modification, when the fluctuation amount in accordance with the rotation amount of the wheel 34 of the mouse 19 is converted into the document moving amount in the step S541, the CPU 11 judges whether or not the moved document number based on the document moving amount is smaller than the predetermined value (N) (step S601). When it is judged by the judgment that the moved document number is not less than the predetermined value (N) (step S601, YES), the CPU 11 advances to the step S542. That is, when the moved document number is not less than the predetermined value, the CPU 11 switches the document displayed in the document searching screen 40 in accordance with the document moving amount by the process of the steps S542 to S511.

Moreover, when it is judged by the judgment that the moved document number is smaller than the predetermined value (N) (step S601, NO), for example, the CPU 11 sets a counter on the RAM 12 to store the moved document number as a counter value. When the counter value indicates 0 (step S602, YES), the CPU 11 advances to the step S501, and is brought into an input waiting state.

Furthermore, when the counter value indicating the moved document number is not “0” (step S602, NO), the CPU 11 judges whether or not the document moving amount indicates a positive value (step S603).

When it is judged that the document moving amount indicates the positive value, that is, when it is judged that the wheel 34 is rotated in the forward direction (step S603, YES), the CPU 11 switches the documents displayed in the document searching screen 40 one by one in the “order” set for each document from the document being displayed to the document having the “order” in accordance with the document moving amount by a process similar to that of the steps S521 to S523 and S528 to S532 (steps S621 to S623, S628 to S632).

That is, in the steps S621 to S623, S628 to S632, in the document searching screen 40, the image of the first page of an old document is displayed every document in order from the document being displayed to the document having the “order” in accordance with the document moving amount in the image display region 41. Moreover, the arrow 43 is displayed which indicates the position of each document in the document map 42.

Moreover, when it is judged by the judgment that the document moving amount indicates a negative value, that is, when it is judged that the wheel 34 is rotated in a reverse direction (step S603, NO), the CPU 11 switches the documents displayed in the document searching screen 40 one by one in order opposite to the “order” set for each document from the document being displayed to the document having the “order” in accordance with the document moving amount by a process similar to that of the steps S521 to S525 to S532 (steps S625 to S632).

That is, in the steps S625 to S632, in the document searching screen 40, the image of the first page of a new document is displayed every document in order from the document being displayed to the document having the “order” in accordance with the document moving amount in the image display region 41. Moreover, the arrow 43 is displayed which indicates the position of each document in the document map 42.

When the process up to the step S632 is completed, the CPU 11 subtracts one from the counter value indicating the moved document number (step S633), and advances to the step S602. Therefore, the process of the steps S602 to S633 is repeatedly executed as many as the moved document number. Accordingly, the image of the first page of each document is successively displayed for documents indicated by the moved document number in the image display region 41 of the document searching screen 40.

It is assumed that in the process of the step S602 to 633, the image of the first page of each document is displayed in the image display region 41 of the document searching screen 40 for a preset display time. The display time of the image of the first page of each document may be set by the user.

As described above, in the first modification, when the moved document number based on the rotation amount of the wheel is smaller than the predetermined value, the image of the first page of the document displayed in the image display region 41 of the document searching screen 40 switches every document in order in accordance with the rotation direction of the wheel. That is, when the user rotates the wheel little by little, or slowly rotates the wheel, the document (the image of the first page) displayed in the image display region 41 switches every document from the document being displayed in order in accordance with the rotation direction of the wheel. Accordingly, the document displayed in the image display region 41 of the document searching screen can be smoothly switched every document in order in accordance with the rotation direction of the wheel. As a result, the user easily finds a desired document.

Furthermore, when the moved document number based on the rotation amount of the wheel is not less than the predetermined value, the image of the first page of the document displayed in the image display region 41 of the document searching screen 40 switches as many as documents corresponding to the moved document number. That is, when the user largely rotates the wheel at a stretch, the document (image of the first page) displayed in the image display region 41 of the document searching screen switches as many as documents corresponding to the rotation amount from the document being displayed. Consequently, to quickly switch the document being displayed to a document having a largely different document time, the user largely rotates the wheel at a stretch, so that the document displayed in the image display region 41 of the document searching screen can be switched at a stretch.

As described above, according to the first modification, it is possible to switch the displayed document in accordance with user's intention. As a result, the operability is enhanced, and the user can efficiently searches for the desired document.

Next, a second modification will be described with reference to the document searching process using the wheel 34.

In the second modification which is a modification of the document searching process using the wheel 34 of the mouse 19, when the document moving amount is not less than a predetermined value, an image of a first page of the document to be displayed is switched in order every document to a moved document from several documents before the document moved in accordance with the document moving amount.

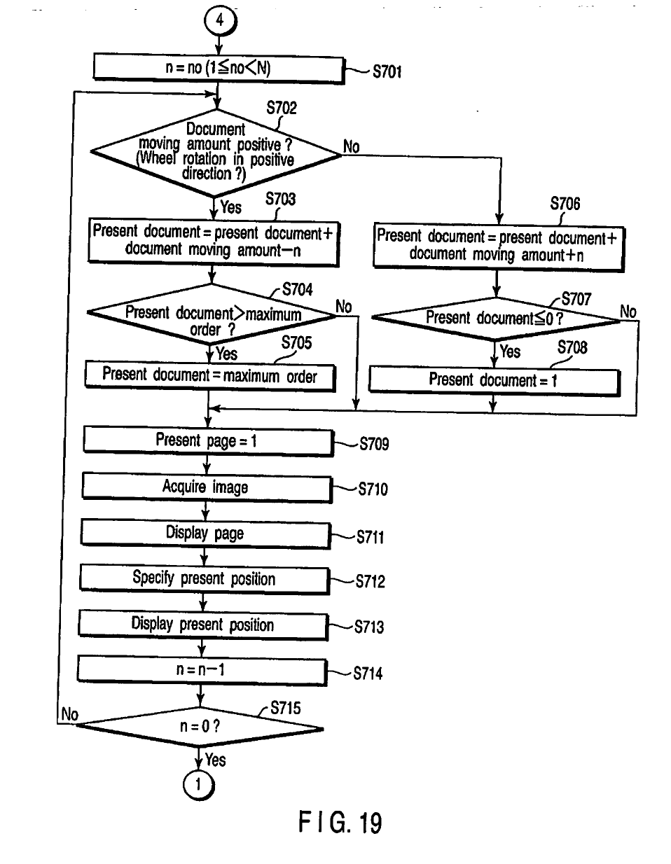

FIG. 19 is a flowchart showing the second modification of the document searching process using the wheel 34 of the mouse 19. The second modification shown in FIG. 19 is a modification of a process continued from that of the step S601. Specifically, the second modification shows a process example in a case where it is judged in the step S601 of the first modification that the moved document number is not less than the predetermined value. Therefore, detailed description is omitted with respect to a process similar to the above-described process.

That is, in the present second modification, when it is judged in the step S601 that the moved document number based on the document moving amount is not less than the predetermined value (N) (step S601, YES), for example, the CPU 11 sets a counter on the RAM 12 to store an initial value n₀ as a counter value n of this counter (step S701). Accordingly, the counter value n of the counter is set to “n=n₀”. It is assumed that the initial value n₀ satisfies “1≦n₀<N”, and is a preset value.

When the initial value n₀ is stored in the counter, the CPU 11 judges whether or not the document moving amount indicates a positive value (step S702). The amount is calculated from the fluctuation amount in accordance with the rotation amount of the wheel 34.

When it is judged by the judgment that the document moving amount indicates the positive value, that is, when it is judged that the wheel 34 is rotated in the forward direction (step S702, YES), the CPU 11 sets “present document+document moving amount−n” to the “present document” (step S703). When the “present document” set in the step S703, that is, the “present document+document moving amount−n” is not more than a “maximum order” (step S704, NO), the CPU 11 displays the image of the first page of the document indicated by the “present document+document moving amount−n” and the arrow indicating the position of the document in the document searching screen 40 by a process similar to the steps S628 to S632 (steps S709 to S713).

It is to be noted that when the “present document” set in the step S703, that is, the “present document+document moving amount−n” is larger than the “maximum order” (step S704, NO), the CPU 11 sets the document whose “order” is the “maximum order” to the present document (sets the “present document” to the “maximum order”) (step S705). In this case, the CPU 11 displays the image of the first page of the document (present document) having the “maximum order” and the arrow 43 indicating the position of the present document in the document searching screen 40 (steps S709 to S713).

Moreover, when it is judged by the judgment that the document moving amount indicates a negative value, that is, when it is judged that the wheel 34 is rotated in a reverse direction (step S702, NO), the CPU 11 sets “present document+document moving amount+n” to the “present document” (step S706). When the “present document” set in the step S706, that is, the “present document+document moving amount+n” is not more than “0” (step S707, NO), the CPU 11 displays the image of the first page of the “present document” indicated by the “present document+document moving amount+n” and the arrow 43 indicating the position of the “present document” in the document searching screen 40 by a process similar to the steps S628 to S632 (steps S709 to S713).

It is to be noted that when the “present document” set in the step S706, that is, the “present document+document moving amount+n” is “0” or less (step S707, YES), the CPU 11 sets the document whose “order” is “1” to the “present document” (sets the “present document” to the document of “1”) (step S708). In this case, the CPU 11 displays the image of the first page of the document (present document) whose “order” is “1” and the arrow 43 indicating the position of the present document in the document searching screen 40 (steps S709 to S713).

When the process up to the step S714 is completed, the CPU 11 sets “n=n−1” to thereby subtract one from the counter value n (step S714). When 1 is subtracted from the counter value n, the CPU 11 judges whether or not the counter value n indicates “0” (step S715). When it is judged by this judgment that the counter value n is “0” (step S715, YES), the CPU 11 advances to the step S502 and is brought into an input waiting state.

Moreover, it is judged by the judgment that the counter value n does not indicate “0” (step S715, NO), the CPU 11 returns to the step S702. Therefore, the process of the steps S702 to S715 is repeatedly executed until the counter value n indicates “0”. Accordingly, in the image display region 41 of the document searching screen 40, the image of the first page of the document is successively displayed every document to the document having the “order” in accordance with the document moving amount from the document whose “order” in accordance with the document moving amount is n₀ before the moved document.

As described above, in the second modification, when the user rotates the wheel by the value that is not less than the predetermined value in the forward direction, the document displayed in the document searching screen 40 switches to the document of “present document+document moving amount−n₀”. Furthermore, in the document searching screen 40, the respective documents are successively displayed every document from “present document+document moving amount−n₀” to the “present document+document moving amount”.

Moreover, even when the user rotates the wheel by the value that is not less than a predetermined value in the reverse direction, the document displayed in the document searching screen 40 is similarly switched to the document of “present document+document moving amount+n₀”. Furthermore, in the document searching screen 40, the respective documents are successively displayed every document from “present document+document moving amount+n₀” to the “present document+document moving amount”.

Consequently, according to the second modification, even when the wheel is rotated at a stretch, a possibility drops that the user skips over the desired document. As a result, efficient document searching is possible. According to the second modification, a plurality of documents is displayed in the document searching screen 40 in accordance with the rotation of the wheel. Therefore, the user easily recognizes the position (e.g., document time, etc.) of the document moved in accordance with the wheel rotation.

Additionally, in the present embodiment, it has been described that the fluctuation amount in accordance with the rotation amount of the whole of the mouse is converted into the document moving amount. However, the above-described embodiment is not limited to the wheel of the mouse. That is, the wheel of the mouse in the above-described embodiment may be replaced as long as the fluctuation amount can be input in the vertical direction in accordance with user's intention. For example, a pointing device such as a track ball and a touch pad is applicable to the present embodiment instead of the wheel of the mouse.

As to the touch pad, the document managing apparatus 1 may acquire as the fluctuation amount an amount by which the user traces a pad portion with fingers. In the touch pad, a change amount of an angle of a touched point from a center on the touch pad may be detected and converted into a fluctuation amount, such as ¼ rotation into an amount corresponding to three documents, and a half rotation into an amount corresponding to six documents. As to the track ball, the document managing apparatus 1 ay acquire as the fluctuation amount an amount by which the user rotates the ball. Additionally, in a general track ball or touch pad, directivity of rotation or movement is unspecified. Therefore, the document managing apparatus 1 acquires the moving amount in the vertical direction as the fluctuation amount in the vertical direction, and converts the fluctuation amount in the vertical direction into the document moving amount so that an embodiment similar to the above-described embodiment can be realized.

It is to be noted that in the present embodiment, it has been described that the function of carrying out the present invention is recorded beforehand in the apparatus, but the present invention is not limited to this embodiment. The similar function may be downloaded to the apparatus from the network, or the similar function stored in a recording medium may be installed in the apparatus. Any mode of the recording medium may be used such as CD-ROM as long as the program can be stored, and read by the apparatus. The function obtained beforehand by the installation or download may be realized in cooperation with an internal operating system (OS) or the like of the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A document managing apparatus comprising:
a document management table which manages an order of a plurality of documents constituting management objects;
a display which displays an image of one of the plurality of documents managed by the document management table;
an input control unit which detects a fluctuation amount input into an input device;
a processing unit to determine the order of the documents to be displayed in the display based on the fluctuation amount detected by the input control unit and the order of the document whose image is displayed in the display, when the input control unit detects the fluctuation amount input by the input device in a state in which one document image is displayed in the display; and
a display control unit which switches the document image displayed in the display to a document image having the order determined by the processing unit.

2. The document managing apparatus according to claim 1, wherein the input control unit detects the fluctuation amount input into a pointing device which is the input device.

3. The document managing apparatus according to claim 1, wherein the input control unit detects as the fluctuation amount a rotation amount of a rotary member disposed in the pointing device which is the input device.

4. The document managing apparatus according to claim 1, wherein the input control unit detects as the fluctuation amount a rotation amount of a wheel disposed in a mouse which is the input device.

5. The document managing apparatus according to claim 1, wherein the input control unit detects as the fluctuation amount an amount of movement on a touch pad which is the input device.

6. The document managing apparatus according to claim 1, wherein the processing unit converts the fluctuation amount detected by the input control unit into a document moving amount indicating the number of documents to be moved, and judges an order obtained by adding the document moving amount to the order of the document whose image is displayed in the display, when the input control unit detects the fluctuation amount input by the input device in a state in which the image of one document is displayed in the display.

7. The document managing apparatus according to claim 6, wherein the processing unit converts the fluctuation amount detected by the input control unit and having a predetermined forward direction into a document moving amount indicating the number of documents to be moved in a positive value, and converts the fluctuation amount detected by the input control unit and having a direction opposite to the forward direction into a document moving amount indicating the number of documents to be moved in a negative value.

8. The document managing apparatus according to claim 6, further comprising:
a memory which stores setting information indicating a relation between the fluctuation amount and the document moving amount,
wherein the processing unit converts the fluctuation amount detected by the input control unit into the document moving amount based on setting information stored in the memory.

9. The document managing apparatus according to claim 6, wherein the display control unit switches the image of the document displayed in the display to an image of a document having the order judged by the processing unit in a case where the document moving amount is not less than a predetermined value, and
switches and displays in the display the image of each document from the document displayed in the display to the document having the order judged by the processing unit every document in order in a case where the document moving amount is smaller than the predetermined value.

10. The document managing apparatus according to claim 6, wherein the display control unit switches and displays in the display the image of each document to the document having the order judged by the processing unit from the document having the order corresponding to a predetermined document number before the order judged by the processing unit every document in order.

11. A document managing apparatus comprising:
document managing means for managing an order of a plurality of documents which are management objects;
displaying means for displaying an image of one of the plurality of documents managed by the document managing means;
input controlling means for detecting a fluctuation amount input into an input device;
processing means for determining the order of the documents to be displayed in the displaying means based on the fluctuation amount detected by the input controlling means and the order of the document whose image is displayed in the displaying means, when the input controlling means detects the fluctuation amount input by the input device in a state in which one document image is displayed in the displaying means; and
display controlling means for switching the document image displayed in the displaying means to a document image having the order determined by the processing means.

12. The document managing apparatus according to claim 11, wherein the input controlling means detects the fluctuation amount input into a pointing device which is the input device.

13. The document managing apparatus according to claim 11, wherein the input controlling means detects as the fluctuation amount a rotation amount of a rotary member disposed in the pointing device which is the input device.

14. The document managing apparatus according to claim 11, wherein the input controlling means detects as the fluctuation amount a rotation amount of a wheel disposed in a mouse which is the input device.

15. The document managing apparatus according to claim 11, wherein the input controlling means detects as the fluctuation amount an amount of movement on a touch pad which is the input device.

16. The document managing apparatus according to claim 11, wherein the processing means converts the fluctuation amount detected by the input controlling means into a document moving amount indicating the number of documents to be moved, and judges an order obtained by adding the document moving amount to the order of the document whose image is displayed in the displaying means, when the input controlling means detects the fluctuation amount input by the input device in a state in which the image of one document is displayed in the displaying means.

17. A document management program which allows a computer to realize:
a document managing function of managing an order of a plurality of documents which are management objects;
a displaying function of displaying in a display an image of one of the plurality of documents managed by the document managing function;
an input controlling function of detecting a fluctuation amount input into an input device;
a processing function of determining the order of the documents to be displayed in the display based on the fluctuation amount detected by the input controlling function and the order of the document whose image is displayed in the display, when the input controlling function detects the fluctuation amount input by the input device in a state in which one document image is displayed in the display; and
a display controlling function of switching the document image displayed in the display to a document image having the order determined by the processing function.

18. The document management program according to claim 17, wherein the input controlling function detects the fluctuation amount input into a pointing device which is the input device.

19. The document management program according to claim 17, wherein the input controlling function detects as the fluctuation amount a rotation amount of a rotary member disposed in the pointing device which is the input device.

20. The document management program according to claim 17, wherein the input controlling function detects as the fluctuation amount a rotation amount of a wheel disposed in a mouse which is the input device.

21. The document management program according to claim 17, wherein the input controlling function detects as the fluctuation amount an amount of movement on a touch pad which is the input device.

22. The document management program according to claim 17, wherein the processing function converts the fluctuation amount detected by the input controlling function into a document moving amount indicating the number of documents to be moved, and judges an order obtained by adding the document moving amount to the order of the document whose image is displayed in the display, when the input controlling function detects the fluctuation amount input by the input device in a state in which the image of one document is displayed in the display.

23. A document managing method comprising:
managing an order of a plurality of documents which are management objects;
displaying in a display an image of one of the plurality of managed documents;
detecting a fluctuation amount input into an input device;
determining the order of the documents to be displayed in the display based on the detected fluctuation amount and the order of the document whose image is displayed in the display, when the fluctuation amount input by the input device is detected in a state in which one document image is displayed in the display; and
switching the document image displayed in the display to a document image having the determined order.

24. The document managing method according to claim 23, wherein the detecting of the fluctuation amount comprises: detecting the fluctuation amount input into a pointing device which is the input device.

25. The document managing method according to claim 23, wherein the detecting of the fluctuation amount comprises: detecting as the fluctuation amount a rotation amount of a rotary member disposed in the pointing device which is the input device.

26. The document managing method according to claim 23, wherein the detecting of the fluctuation amount comprises: detecting as the fluctuation amount a rotation amount of a wheel disposed in a mouse which is the input device.

27. The document managing method according to claim 23, wherein the detecting of the fluctuation amount comprises: detecting as the fluctuation amount an amount of movement on a touch pad which is the input device.

28. The document managing method according to claim 23, wherein the judging of the order of the document to be displayed in the display comprises: converting the detected fluctuation amount into a document moving amount indicating the number of documents to be moved, and judging an order obtained by adding the document moving amount to the order of the document whose image is displayed in the display, when detecting the fluctuation amount input by the input device in a state in which the image of one document is displayed in the display.
